(19) United States
(12) Patent Application Publication
(10) Pub. No.: US 2010/0242175 A1
(43) Pub. Date: Sep. 30, 2010

(54) HIGH-LIFT RM- COMPATIABLE ADJUSTABLE RADIOLOGICAL TABLE

(76) Inventors: Mauro Di Giancamillo, Milano (IT); Davide Danilo Zani, Torbiato di Adro (Brescia) (IT)

Correspondence Address: Steinfl & Bruno, 301 N Lake Ave Ste 810, Pasadena, CA, 91101, US

(21) Appl. No.: 12/515,936

(22) PCT Filed: Nov. 20, 2007
(86) PCT No.: PCT/IT07/00812

§ 371 Date: Oct. 5, 2009

(30) Foreign Application Priority Data
Nov. 23, 2006 (IT) MI2006A002249

(51) Int. Cl. A61G 13/06

(52) U.S. Cl. 5/601

(57) ABSTRACT

The present invention relates to a table for diagnostic analyses for veterinary or medical use. In particular, the present invention relates to a non-magnetic diagnostic table (1), comprising a support structure (2) and a platform (3), characterized in that said platform (3) is radiotransparent and that said table (1) includes a pneumatic system for raising said platform (3) comprising stabilizer means (100), said stabilizer means (100) comprising valve means (15) that are actuated by control means (16) which receive information on the vertical positioning of said platform (3) by means of mechanical drive.

The present invention relates to a table for diagnostic analyses for veterinary use, particularly on large animals such as bovines, equines, or swine, or for medical use.

In the veterinary field, it is a current use to screen animals by instrumental type diagnostic analyses, most commonly conventional radiological analysis (X-rays), and Nuclear Magnetic Resonance (NMR). There are many problems related to instrumental analysis on large animals, such as bovines, equines, or swine. A first problem is related to the high weight of such animals. The table on which the animal is laid not only is required to be able to support a weight of several hundreds of kilograms, but also requires to be height-adjustable, so as to allow the proper positioning of the animal's part to be analyzed relative to the analytical equipment. Furthermore, during X-ray radiological analysis, the table shall be radiotransparent. Vice versa, NMR analysis will require a table made from a non-magnetic material, so as to avoid any interference with the analysis, being carried out.

Until now, a radiological table dedicated to radio diagnostics in large animals, specifically in the horse, does not exist. In general, use is made of makeshift, by adapting (mostly surgical) tables with a number of metallic members, which are extremely heavy and poorly flexible for routine use in an X-ray room, where the system consisting of the high-power X-ray tube and the cassette holder of the stand are mounted on suspended telescopic arms provided with rails. On the other hand, non-magnetic tables for large animals are commercially available which, however, provide for the employment of high atomic number materials which, if used in radiology, would not promote the passage of the radiation beam. The use of such tables, therefore, remains strictly confined to NMR analyses.

Another major problem is related with the large size of the tables that are intended to support large animals, which makes difficult for the same to be handled and introduced in the shielded chambers in which the analysis equipment is located.

Similar problems are faced when diagnostic analyses or surgical procedures are carried out on humans with severe obesity, having a weight which can also be up to 200-300 Kg. Tables being able to handle such patients do not currently exist.

The object of the present invention is thus to provide a table for instrumental analyses or surgical operations, and which is usable both for radiological analyses and NMR analyses.

This object is achieved by means of a table such as outlined in the appended claims, the definitions of which are an integral part of the present specification.

The present invention will be better described by means of several preferred embodiments, which are provided by way of non-limiting examples, with reference to the annexed drawings, in which:

FIG. 1 shows a top plan phantom view of the table according to the invention;

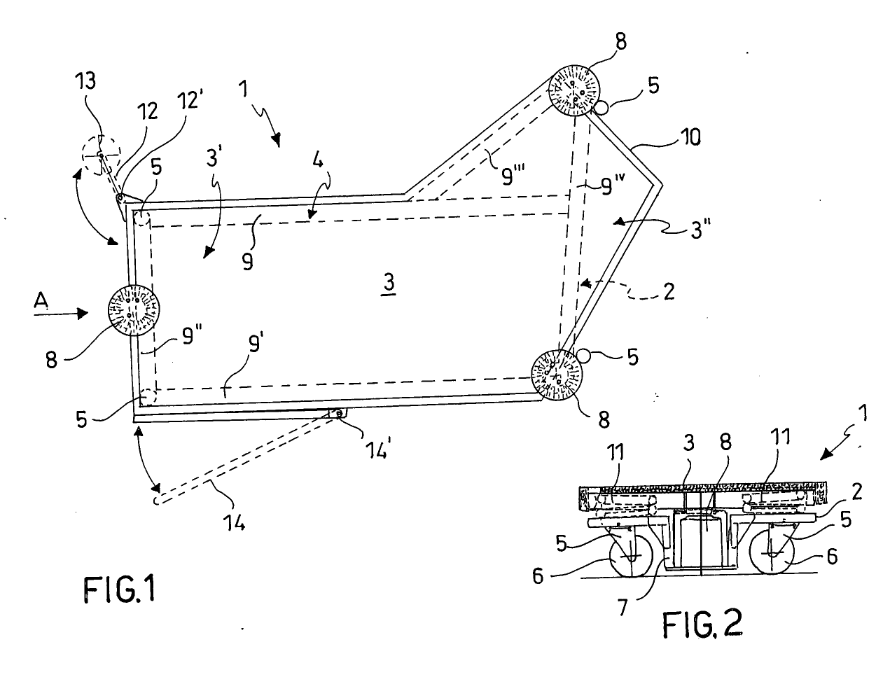

FIG. 2 shows a side view according to the direction A of the table of FIG. 1;

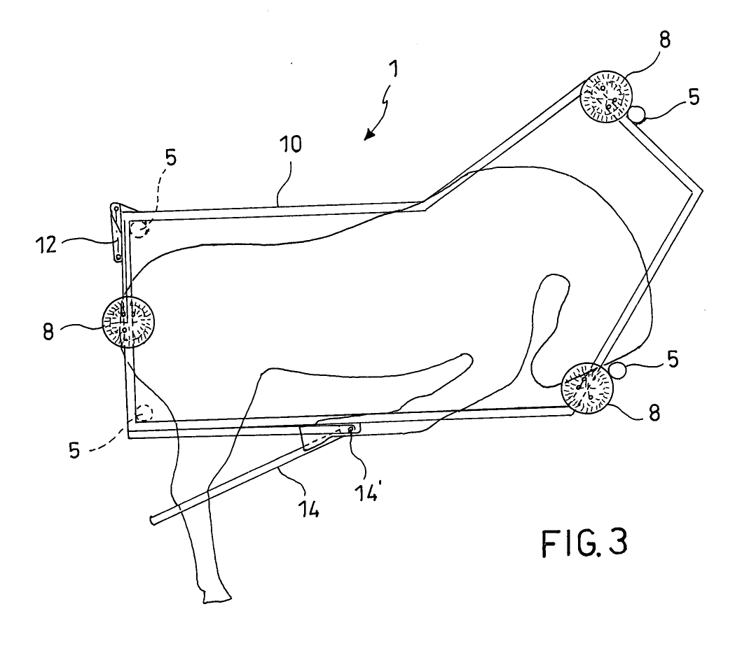

FIG. 3 shows a top plan view of the table of FIG. 1 with the outline of a horse depicted therein;

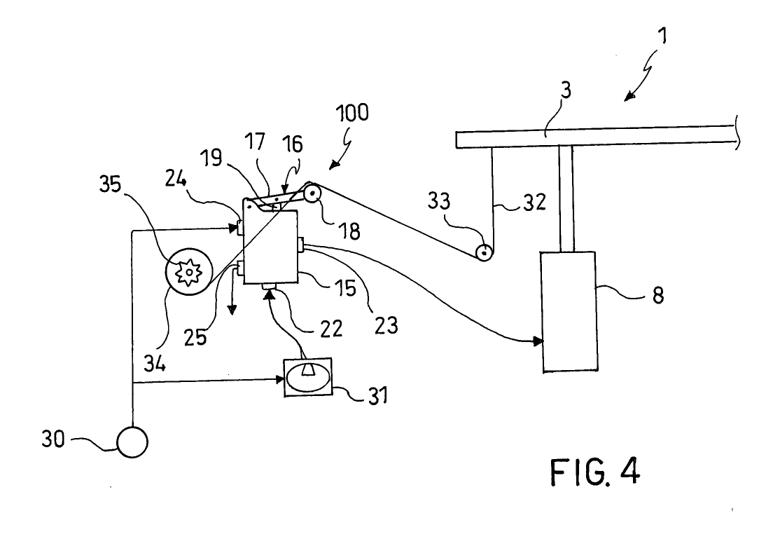

FIG. 4 shows a schematic view of the elevation device of the table of FIG. 1;

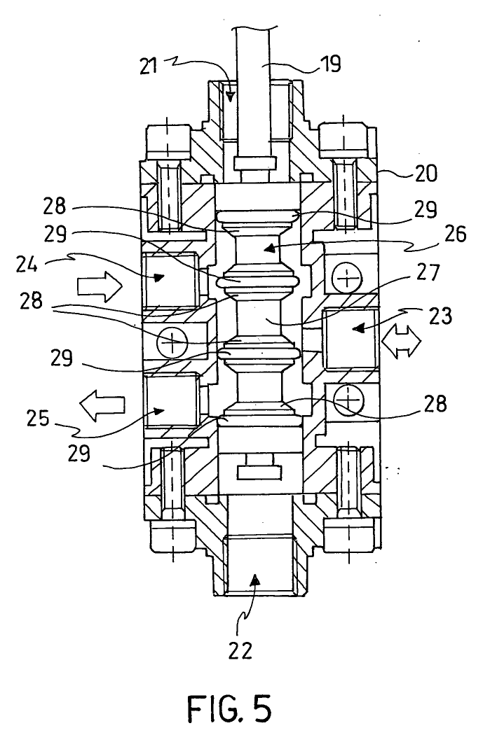

FIG. 5 shows a sectional view of the valve means for the pneumatic actuation of the elevation device of FIG. 4.

With reference to the figures, the table according to the invention, generally designated by the numeral 1, comprises a support structure 2 and a platform 3.

The support structure 2 comprises a frame 4, with feet 5 being rotatably fastened at the vertexes thereof, each of them carrying a wheel 6. Thereby, the feet 5 can rotate around a vertical axis, facilitating handling the table 1 also in case of complex maneuvers, such as those being required for introducing the table in NMR rooms or in similar confined environments.

The frame 4 further comprises brackets 7, each of which is intended to support actuating means 8, which are suitable to carry out a controlled elevation of the platform 3, as will be better described herein below. In the preferred embodiment shown in the figures, these actuating means 8 are three, two of which being located at two vertexes of the table 1, while the third actuating means 8 is located on a side of the table 1 opposite to the first two ones. Nothing prevents, in different embodiments, from using either an individual actuating means that is centrally located under the platform 3, or two actuating means 8 being located on opposite sides, or, again, more than three actuating means. However, the embodiment shown herein allows achieving a good balancing of the load weights, by always keeping the platform 3 in the horizontal position; on the other hand, the preferred arrangement allows keeping the space under the platform 3 free, thus allowing the radiological cassette to be easily inserted during a radio diagnostics analysis.

To the same purpose, the frame 4 comprises bars 9, 9′, 9″, 9′″, 9″″ which mainly extend along the frame periphery, without creating substantial encumbrance in the region below the platform 3.

The frame 4, having to support an elevated weight, is made of a high-lift material which, concomitantly, has to be non-magnetic, in order to avoid interfering with the equipment during NMR diagnostic analysis. Preferably, this material is stainless steel.

In the preferred embodiment of the drawings, the frame 4 does not have a plan rectangular shape, but an asymmetric shape which substantially matches the shape of the platform 3. In fact, the platform 3 comprises a first portion 3′ of a substantially rectangular shape, and a second portion 3″ which extends from the first portion 3′, forming an obtuse angle therewith, and slightly tapering towards the end side 10, thus taking a substantially trapezoidal shape. This shape ensures, on the one hand, a proper support for the animal, since it is a substantially anatomic shape (see FIG. 3); on the other hand, it allows the overall dimensions to be minimized. This latter feature is essential in order to ensure an easy handling of the table 1, particularly during the step of introducing the table through the doors of NMR or radiological rooms.

Furthermore, the platform 3 must be made of a resistant material, in order to withstand high weights as expected. Basically, the platform 3 has to be made in a non-magnetic material (in order to avoid interfering with NMR diagnostics), and radiotransparent (in order to avoid interfering with radio diagnostics). Such material is preferably polymethylmethacrylate or polycarbonate, where a structure which is also light-transparent is deemed to be required, or, alternatively, carbon fiber.

The bottom of the platform 3 is fastened to the frame 4 through suitable guide means 11, so as to allow the platform 3 to be lifted relative to the frame 4. In the example of the figures, such guide means 11 consist of articulated levers, though other known systems may as well be used.

The bottom of the platform 3 is further fastened to the piston of the actuating means 8.

A rod 12 is fastened to a corner of the table 1, in an articulated manner through a suitable hinge 12′, which rod has a pan 13 at the distal end thereof, so as to act as a support means for a part of the animal's body which, in some circumstances, may protrude from the table 1. Particularly, the pan 13 is suitable to support the animal's head, when it is laid in the reversed position as compared to that shown in FIG. 3.

Similar support means, such as a rod 14 being hinged to the frame 4 through a hinge 14′, may be arranged on the table 1 sides, to the same purpose, in suitable positions for supporting the protruding parts of the animal. The articulated joint allows retracting the support means 12, 13, 14 when they are not used or, however, in each situation in which the size of the table 1 requires to be reduced.

The elevation system for the platform 3 by means of the actuating means 8 will be now described.

The actuating means 8 should be made of non-magnetic material, and no electric or electronic devices should be comprised therein, in order to prevent any interference with the diagnostic devices during NMR analysis. To this purpose, said actuating means 8 preferably consist of pneumatic actuators, which, unlike hydraulic actuators, ensure rapid response to the actuating control, without requiring electric or electronic devices for operation. Advantageously, pneumatic actuators may be used of the same type as those known as the air springs which are used in truck and full trailers suspensions. To the purpose of the invention, such actuators will comprise a rubber pocket, a polymeric material piston and a stainless steel counter-plate, thus ensuring the non-magnetic feature that is required by the particular use as specified herein. Of course, other types of pneumatic actuators may also be used.

A problem that the elevation system used in the inventive table 1 should solve is related to the requirement of maintaining the platform 3 in a horizontal position both during the elevation phase and during the stationary phase. Particularly, the actuating means 8 act separately and, therefore, stabilizer means 100 have to be arranged which are capable to adjust any possible deviations of the platform 3 from the planarity required.

As shown in FIG. 4, the stabilizer means 100 according to the invention comprise valve means 15 that are actuated by control means 16 which receive information on the vertical positioning of the platform 3 by means of mechanical drive.

The valve means 15 preferably consist of cassette or shuttle valve means of the 3/2 ways type, in which the control means 16 are a roller lever consisting of a lever 17 that is hinged to the box of the valve means 15, a roller 18 being rotatably located at the opposite end thereof. A control pin 19 is hinged on the lever 17, so as to be able to slide along a vertical axis under the effect of the lever 15 pivoting about the hinge thereof.

The valve means 15 shown in FIG. 5 are of a conventional type, but they will be however described in the most general aspects thereof for clarity reasons. They comprise a hollow body 20, which is provided with an upper opening 21, in which the control pin 19 of the control means 16 is fitted, and a lower opening 22. Other three openings are located on the side walls of the hollow body 20, and particularly:
a delivery port 23, which is provided on a side of the hollow body 20, approximately at the central position;
an inlet port 24, which is located on a side opposite the delivery port 23 and in an upwardly offset position relative to the latter;
a vent port 25, which is located on the same side of the inlet port 24, but in a lower and downwardly offset position relative to the delivery port 23.

Selection means 26, for the selection of inlets and outlets of the valve means 15 following a suitable control, are slidingly located inside the hollow body 20. Such selection means comprise a shuttle consisting of a shaft 27 with a lower diameter than the diameter of the cavity of the hollow body 20, said shaft 27 comprising, at the ends thereof, and in intermediate positions, four enlarged sections 28. As many O-rings 29 having such a size as to interfere with the cavity walls of the hollow body 20 are located on said enlarged sections 28.

The selection means 26, as stated above, are slidable within the hollow body 20. In the position as shown in FIG. 5, the inlet port 24 and the delivery port are in fluid communication with each other; on the contrary, if the selection means 26 are caused to slide downward, the inlet port 24 will be cut off, while the vent port 25 and the delivery port 23 will be put in a fluid communication. Due to the hysteresis of the valve means 15, there will be a position of the selection means 26 where all the ports are isolated: such position will correspond to a balance state of the system, i.e. the condition in which the platform 3 stays still in the predetermined position.

As shown in FIG. 4, the delivery port 23 of the valve means 15 is pneumatically connected to the actuating means 8 by means of a suitable tubing.

A high-pressure gas source 30 is pneumatically connected to the inlet port 24 of the valve means 15. Such high-pressure gas is typically compressed air. Said source 30 may be a cylinder or a pressurized container, or a suitably sized blower.

The lower port 22 is also connected to the high pressure gas source 30, through a suitable pneumatic tubing, with a pressure reducer 31 being previously interposed in the line. The pressure reducer 31 is of the conventional type and comprises a system for adjusting the outlet pressure. Thereby, a pneumatic spring is provided which hinders the selection means 26 of the valve means 15 to slide downward under the action of the pin 19. Through the pressure reducer 31, the pre-load of this pneumatic spring may be calibrated such that the latter will provide to keep the selection means 26 in the high-level position until when the lever 17 and the relative pin 19 actuation will overcome the preload, as described herein below.

A cable, preferably a steel cable, 32 is secured to the platform 3 lower surface. Preferably, the cable 32 is secured in a position adjoining the point where the actuating means 8 are acting. The cable 32 first intercepts a pulley 33, which provides for tensioning the same along a vertical axis, and then the roller 18 of the control means 16 of the valve means 15; in the end, at the end opposite the platform 3, the cable 32 is wound on a rotatably adjustable drum 34.

The drum 34 is caused to rotate through suitable actuating means 35, preferably a handle. The handle 35 is preferably uncoupled from the drum by means of a spring and a friction system of the conventional type (not shown), for example a mat friction. This feature allows higher safety of use, by avoiding undue tearing to the cable 32 also in the case of slow reaction by the valve means 15—due to the hysteresis thereof—following the system shifting to a different state.

In case of a number of actuating means 8 acting in different points of the platform 3, said stabilizer means 100 will be associated with each of them. In this case, the relative cables 32, which are all secured to different points of the platform 3, will be preferably wound on the same drum 34. In fact, in this way the several actuating means 8 will be raised/lowered in a synchronized manner, thus allowing the platform 3 to be kept in a planar condition at any time.

Still with reference to the figures, the operation of the elevation system of the inventive table for veterinary or medical use will be now described.

When the cable 32 is wound on the drum 34, a tensioning of the cable 32 will be produced which, by imparting a higher pressure upon the lever 17 through the relative roller 18, will then produce a lowering of the pin 19, thus overcoming the preload of the pneumatic spring being located at the bottom of the valve means 15, as described above. The preload of this pneumatic spring shall therefore be finely adjusted by means of the pressure reducer 31. In this situation, the selection means 26 will obstruct the inlet port 24 and will set the delivery port 23 and the vent port 25 in fluid connection with each other. The gas therefore will only flow from the actuating means 8 to the vent port 25, thus causing a lowering of the platform 3.

Vice versa, when the cable 32 is unwound from the drum 34, the cable 32 will get loose, and the pneumatic spring of the valve means 15 will provide for bringing the selection means 26 back to the upper position; as a result, the high-pressure gas source 30 will be set in communication with the actuating means 8. An elevation of the platform 3 will be thus achieved.

The operation of the elevation system upon a specific command by the user in order to raise or lower the platform 3 has been described herein above.

The stabilizer means 100, however, are also operated in the case when, for some reasons, a deviation from the planar condition of the platform 3 occurs. This can take place, for example, when, due to a shift of the animal's mass, the platform tends to swing, tilting towards a side thereof and correspondently raising on the opposite side.

In such a case, the drum 34 stays still, but, when the platform 3—on the side that is moving downward—moves to the pulley 33, the cable 32 releases the tension on the lever 17. Thereby, the pin 19 does not apply pressure on the selection means 26 anymore, and these are raised by the pneumatic spring of the valve means 15, until the inlet port 24 for the compressed gas and the delivery port 23 are set in communication with each other. The compressed gas being fed in the actuating means 8 will cause the latter to be raised, until reaching the balance position (initial position), when the tensioning of the cable 32 will cause the valve means 15 to be closed again.

At the same time as this adjustment occurs on the side of the platform 3 which is downwardly tilted, the stabilizer means 100 associated with the actuating means 8 being located on the opposite side, under the effect of the platform elevation, will get out from the balance condition and will discharge compressed gas from the corresponding actuating means 8, with a mechanism similar to that described above.

It should be thus understood that the elevation system of the platform 3 according to the invention, due to the stabilizer means 100, allows for the automatic adjustment of the position of platform 3, without the aid of electronic equipment which, as stated above, would prevent the same from being employed in a Nuclear Magnetic Resonance room.

The non-magnetic and radiotransparent materials, of which the table 1 of the invention is made, make it suitable for being employed both in radio diagnostics and nuclear magnetic resonance.

The particular shape of the table 1 and the arrangement of suitable retractable supports achieves the object of minimizing the dimensions, while ensuring an optimal support for the animal or human thereon. This feature is very important, since the handling of a diagnostic table for large subjects usually arises many problems.

As will be apparent to those skilled in the art from the above descriptions of a preferred embodiments of the invention, what has been illustrated and described herein should be obviously construed as a non-limiting example of the scope of protection of the present invention such as defined in the annexed claims.

1. A non-magnetic diagnostic or surgical table for veterinary or medical use, comprising
a support structure and
a platform,
wherein
said platform is radiotransparent, and
said table includes a pneumatic system for raising said platform comprising stabilizer means, said stabilizer means comprising valve means which are actuated by control means that receive information on the vertical positioning of said platform by means of a mechanical drive.

2. The table according to claim 1, wherein said pneumatic system for raising said platform comprises actuating means that are connected to a high-pressure gas source through said valve means.

3. The table according to claim 1, wherein said control means comprise a lever hinged at an end thereof to said valve means and comprising a roller at the other end thereof, a pin for the actuation of said valve means being hinged to said lever.

4. The table according to claim 1, wherein said valve means is a 3/2 ways valve, comprising an upper opening for inserting said pin of the control means; a lower port connected to said high-pressure gas source through a pressure reducer; a delivery port connected to said actuating means; an inlet port connected to said high-pressure gas source; and a vent port.

5. The table according to claim 4, wherein said pin acts upon selection means of said delivery, inlet, and vent ports, such that said selection means put said inlet port and said delivery port or, alternatively, said delivery port and said vent port in fluid communication with each other.

6. The table according to claim 4, wherein said valve means comprise a pneumatic spring being provided by feeding compressed gas through said lower port, preload of said pneumatic spring being caused by said pressure reducer.

7. The table according to claim 1, wherein said stabilizer means comprise a cable which is secured at an end thereof to said platform and wound at the other end thereof on a rotatably adjustable drum, said cable intercepting a pulley, which is located in a position such as to tensioning said cable in a vertical position, and said roller of the control means of the valve means, so that tensioning or loosening of said cable act upon said control means.

8. The table according to claim 7, wherein said drum comprises actuating means that are uncoupled from said drum through a spring and friction system.

9. The table according to claim 1, wherein said actuating means are three and are located on opposite sides of said table.

10. The table according to claim 1, wherein said support structure comprises a frame, with feet, each foot carrying a wheel rotatably fastened near to the vertices thereof.

11. The table according to claim 10, wherein the frame comprises bars which mainly extend along a frame periphery, without creating a substantial encumbrance in a region below said platform.

12. The table according to claim 1, wherein said platform comprises a first portion having a substantially rectangular shape, and a second portion which extends from the first portion forming an obtuse angle therewith and is tapered towards an end side, thus assuming a substantially trapezoidal shape.

13. The table according to claim 10, wherein the bottom of said platform is fastened to the frame through guide means, so as to allow raising the platform relative to the frame.

14. The table according to claim 1, said table comprising retractable support means for limbs or head of an animal.

15. The table according to claim 1, wherein said table is made of stainless steel.

16. The table according to claim 1, wherein said platform is made of polymethylmethacrylate, polycarbonate, or carbon fiber.
